(19) United States
(12) Patent Application Publication
(10) Pub. No.: US 2008/0193732 A1
(43) Pub. Date: Aug. 14, 2008

(54) LUMINESCENT FIBER AND MATERIAL THEREOF

(75) Inventors: Hsieh-Chih Chen, Hsinchu County (TW); Wen-Chang Chen, Taipei City (TW); Chi-Ching Kuo, Yunlin County (TW); Yu-Cheng Liu, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: TAIWAN TEXTILE RESEARCH INSTITUTE, Taipei Hsien (TW)

(21) Appl. No.: 11/960,738

(22) Filed: Dec. 20, 2007

(30) Foreign Application Priority Data
Feb. 12, 2007 (TW) 96105007

(51) Int. Cl. B32B 7/02; B32B 27/00

(52) U.S. Cl. 428/220; 428/394

(57) ABSTRACT

A luminescent fiber material suitable for being made through an electro-spinning process is provided. The luminescent fiber material includes a blend of a conjugated luminescent polymer and a transparent non-conjugated polymer. The luminescent fiber made by the material has a diameter about 50-3000 nm.

### CROSS-REFERENCE TO RELATED APPLICATION

This application claims the priority benefit of Taiwan application serial no. 96105007, filed on Feb. 12, 2007. The entirety of the above-mentioned patent application is hereby incorporated by reference herein and made a part of this specification.

### BACKGROUND OF THE INVENTION

1. Field of the Invention

The present invention relates to a luminescent fiber and a material thereof. More particularly, the present invention relates to a luminescent fiber suitable for being made through an electro-spinning process and a material thereof.

2. Description of Related Art

Luminescent fiber is one of the fiber materials attracting much attention, which can be applied in various industries, for example, personal textiles, aviation and automobile decorations, home decorations, medical detection, outdoor goods, and safety facilities. The conventional methods for making luminescent fibers include melt spinning process, solution spinning process, surface coating process, and so on. However, the size of the fiber made by the conventional method cannot meet the requirements for the nanotechnology that has been vigorously developed recently, so the research about making luminescent fibers through an electro-spinning process has been proposed. However, as most of the luminescent fiber materials are brittle materials, there is a problem to be urgently solved by researchers that fibers are likely to break during the electro-spinning process in practice.

### SUMMARY OF THE INVENTION

Accordingly, the present invention is directed to a luminescent fiber material, which is a continuous nano-fiber.

The present invention is further directed to a luminescent fiber, which has a diameter at nano-scale.

As embodied and broadly described herein, the present invention provides a luminescent fiber material, which is suitable for being made through an electro-spinning process. The luminescent fiber material includes a blend of a conjugated luminescent polymer and a transparent non-conjugated polymer.

In an embodiment of the present invention, the conjugated luminescent polymer is selected from a group consisting of poly-3-alkylthiophene and derivatives thereof, polyfluorene (PF) and derivatives thereof, poly-p-phenylene and derivatives thereof, poly(carbazole), poly(indole), polyquinoline and derivatives thereof, poly(quinoxaline), poly(pyridine), polyphenylene vinylene (PPV) and derivatives thereof.

In an embodiment of the present invention, the PF and derivatives thereof include poly(dialkyl fluorene), poly(fluorene-co-thiophene), poly(fluorene-co-bithiophene), poly(fluorene-co-benzothiadiazole), poly(fluorene-co-quinoxaline), poly(fluorene-co-fluorene-co-thienopyrazine) and derivatives thereof.

In an embodiment of the present invention, the PPV derivatives include poly(2-methoxy-5-(2′-ethylhexyloxy)-1,4-phenylene vinylene (MEH-PPV), poly(2-methoxy-5-(2-ethylhexyloxy)-1,4-(1-cyanovinylenephenylene), or poly-2,5-bis(3′,7′-dimethyloctyloxy)-1,4-phenylene vinylene).

In an embodiment of the present invention, the transparent non-conjugated polymer is selected from a group consisting of polyacrylate and derivatives thereof, polyethylene and derivatives thereof, polystyrene (PS) and derivatives thereof, polyvinyl pyridine and derivatives thereof, polyacrylamide, polyvinyl alcohol (PVA), polyester (PES), polycarbonate (PC), cyclic olefin, and polyacrylic acid (PAA).

In an embodiment of the present invention, the polyacrylate derivatives include polymethyl acrylate, poly(n-butylacrylate), or poly(tert-butyl acrylate).

In an embodiment of the present invention, the conjugated luminescent polymer is PPV, and the transparent non-conjugated polymer is poly(methylmethacrylate) (PMMA).

In an embodiment of the present invention, a weight ratio of the conjugated luminescent polymer to the transparent non-conjugated polymer is from 1/99 to 99/1.

In an embodiment of the present invention, the luminescent fiber material further includes a solvent or a co-solvent. The solvent includes tetrahydrofuran (THF), toluene, chloroform, or dimethyl formamide (DMF). The co-solvent is a co-solvent formed by at least two solvents selected from THF, toluene, chloroform, and DMF. When the co-solvent is formed by THF and DMF, a volume ratio of THF to DMF is from 100/0 to 50/50.

In an embodiment of the present invention, the luminescent fiber material further includes a salt. The salt includes a tetramethylammonium salt. Furthermore, based on the total weight of the luminescent fiber material, the content of the salt is less than 5 wt %.

The present invention further provides a luminescent fiber, which is made by using the luminescent fiber material through an electro-spinning process.

In another embodiment of the present invention, the luminescent fiber has a diameter of about 50 nm-3000 nm.

As the present invention adopts a blend of a conjugated luminescent polymer and a transparent non-conjugated polymer as a luminescent fiber material and utilizes an electro-spinning process, a continuous nano-scaled luminescent fiber can be made.

In order to make the aforementioned and other objects, features, and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a luminescent fiber made through an electro-spinning process according to an embodiment of the present invention.

### DESCRIPTION OF EMBODIMENTS

The luminescent fiber material of the present invention includes a blend of a conjugated luminescent polymer and a transparent non-conjugated polymer.

For example, the conjugated luminescent polymer is selected from a group consisting of poly-3-alkylthiophene and derivatives thereof, polyfluorene (PF) and derivatives thereof, poly-p-phenylene and derivatives thereof, poly(carbazole), poly(indole), polyquinoline and derivatives thereof, poly(quinoxaline), poly(pyridine), polyphenylene vinylene (PPV) and derivatives thereof.

The PF and derivatives thereof are, for example, poly(dialkyl fluorene), poly(fluorene-co-thiophene), poly(fluorene-co-bithiophene), poly(fluorene-co-benzothiadiazole), poly(fluorene-co-quinoxaline), poly(fluorene-co-fluorene-co-thienopyrazine) and derivatives thereof.

The PPV derivatives are, for example, poly(2-methoxy-5-(2′-ethylhexyloxy)-1,4-phenylene vinylene (MEH-PPV), poly(2-methoxy-5-(2-ethyl hexyloxy)-1,4-(1-cyanovinylenephenylene), or poly-2,5-bis(3′,7′-dimethyl octyloxy)-1,4-phenylene vinylene).

The transparent non-conjugated polymer of the present invention is, for example, selected from a group consisting of polyacrylate and derivatives thereof, polyethylene and derivatives thereof, polystyrene (PS) and derivatives thereof, polyvinyl pyridine and derivatives thereof, polyacrylamide, polyvinyl alcohol (PVA), polyester (PES), polycarbonate (PC), cyclic olefin, and polyacrylic acid (PAA).

The polyacrylate derivatives are, for example, polymethyl acrylate, poly(n-butylacrylate), or poly(tert-butyl acrylate).

The weight ratio of the conjugated luminescent polymer to the transparent non-conjugated polymer is from about 1/99 to 99/1.

Furthermore, the luminescent fiber material of the present invention further includes a solvent or a co-solvent. For example, the solvent includes tetrahydrofuran (THF), toluene, chloroform, or dimethyl formamide (DMF). The co-solvent may be a co-solvent formed by at least two solvents selected from THF, toluene, chloroform, and DMF. When the co-solvent is formed by THF and DMF, the volume ratio of THF to DMF is from 100/0 to 50/50.

The luminescent fiber material of the present invention may further include a salt, for example, tetramethylammonium salt such as tetramethylanmmonium chloride (TMAC). Furthermore, based on the total weight of the luminescent fiber material, the content of the salt is less than about 5 wt %.

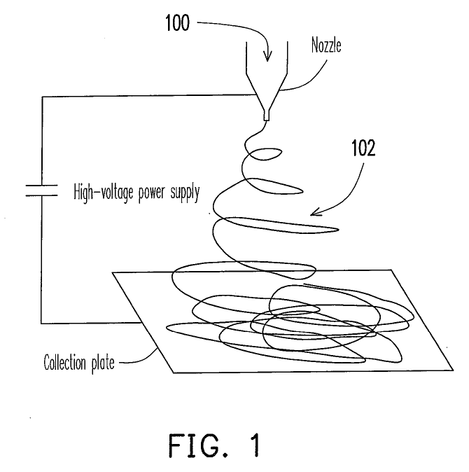

FIG. 1 is a schematic view of a luminescent fiber made through an electro-spinning process according to an embodiment of the present invention.

Referring to FIG. 1, a blend of a conjugated luminescent polymer and a transparent non-conjugated polymer is first dissolved in an appropriate solvent (for example, toluene), so as to form a luminescent fiber material of the present invention. Next, the blended luminescent fiber material 100 is fed into a nozzle, and then a high-voltage power supply is used to apply a high-voltage power, so as to eject the luminescent fiber material 100 from the end of the nozzle to form a liquid column. After the formation of the liquid column, under a strong horizontal electric field, after the charged liquid column is stretched and whipped, the solvent on the liquid column is continuously volatilized, and the diameter of the liquid column is greatly reduced from hundreds of microns to tens of nanometers, and thus forming extremely fine fibers. Thereafter, the fibers may be collected by a grounded collection plate to get nano-scaled luminescent fibers 102, which have a diameter of about 50 nm-3000 nm.

Furthermore, the diameter and the luminescence properties for the luminescent fiber material of the present invention can be controlled by the blending ratio for the polymers, types and ratio of the single solvent or the co-solvent, solution concentration, additives, externally-applied voltage, and flow rate, and so on.

The optical properties for the luminescent fiber of the present invention are illustrated below in detail through an experimental example.

### EXPERIMENTAL EXAMPLE

In the experimental example, poly(2,3-dibutoxy-1,4-phenylene vinylene (DB-PPV) is used as the conjugated luminescent polymer, and PMMA is used as the transparent non-conjugated polymer, and the weight ratios there-between are respectively 5/95, 10/90, and 15/85. The co-solvent formed by THF and DMF is used, and the volume ratio is 50/50. In addition, based on the total weight of the luminescent fiber material, 2 wt % of TMAC is further added. The experimental condition includes: the distance from the end of the nozzle to the collection plate is between 10 cm and 25 cm, the high-voltage power is 12 KeV to 30 KeV, and the flow rate is about 0.1 ml/h to 10 ml/h.

Table 1 below respectively shows the luminescent fiber material made through a conventional coating process and that made through the electro-spinning process of the present invention. It can be known from Table 1, regardless of the weight ratio of 5/95, 10/90, or 15/85, the luminescent fibers made through the electro-spinning process in the present invention have higher luminous efficiency than the luminescent fibers made through the conventional coating process.

TABLE 1

| | Relative Luminescence Quantum |
|---|---|
| | Efficiency (%) |
| Material (DB-PPV/PMMA) | Excited at 400 nm |
| 5:95^{a)} | 18.3 |
| 5:95^{b)} | 29.2 |
| 10:90^{a)} | 23.5 |
| 10:90^{b)} | 40.7 |
| 15:85^{a)} | 21.5 |
| 15:85^{b)} | 22.3 |

^{a)}refers to the conventional coating process.
^{b)}refers to the electro-spinning process in the present invention.

Total concentration is 100 mg/ml.

To sum up, as the present invention uses a conjugated luminescent polymer and a transparent non-conjugated polymer as the luminescent fiber material, a continuous nano-scaled luminescent fiber can be made through the electro-spinning process. The luminescent fiber of the present invention not only can be used in various industries, for example, personal textiles (such as sports goods, gloves, boots, sports shoes, backpacks, and bags), aviation and automobile decorations (such as leather cases, leather chairs, steering wheels, and dashboard coatings), home decorations (table cloths, curtains, furniture, and inner wall coatings), medical detection (biosensors, disposable medical materials), outdoor goods (outdoor cloths, tents, flags, awnings, roof, and boats), safety facilities (fire clothing, high-resistance baffle, high-voltage-insulating gloves), but also can be applied in conductive, luminous, sensing, and electrode materials.

It will be apparent to those skilled in the art that various modifications and variations can be made to the structure of the present invention′without departing from the scope or spirit of the invention. In view of the foregoing, it is intended that the present invention cover modifications and variations of this invention provided they fall within the scope of the following claims and their equivalents.

What is claimed is:

1. A luminescent fiber material, suitable for being made through an electro-spinning process, comprising a blend of a conjugated luminescent polymer and a transparent non-conjugated polymer.

2. The luminescent fiber material as claimed in claim 1, wherein the conjugated luminescent polymer is selected from a group consisting of poly-3-alkyl thiophene and derivatives thereof, polyfluorene (PF) and derivatives thereof, poly-p-phenylene and derivatives thereof, poly(carbazole), poly(indole), polyquinoline and derivatives thereof, poly(quinoxaline), poly(pyridine), polyphenylene vinylene (PPV) and derivatives thereof.

3. The luminescent fiber material as claimed in claim 2, wherein the PF and derivatives thereof comprise poly(dialkyl fluorene), poly(fluorene-co-thiophene), poly(fluorene-co-bithiophene), poly(fluorene-co-benzothiadiazole), poly(fluorene-co-quinoxaline), poly(fluorene-co-fluorene-co-thienopyrazine), and derivatives thereof.

4. The luminescent fiber material as claimed in claim 2, wherein the PPV derivatives comprise poly(2-methoxy-5-(2′-ethylhexyloxy)-1,4-phenylene vinylene (MEH-PPV), poly(2-methoxy-5-(2-ethyl hexyloxy)-1,4-(1-cyanovinylenephenylene), or poly-2,5-bis(3′,7′-dimethyl octyloxy)-1,4-phenylene vinylene).

5. The luminescent fiber material as claimed in claim 1, wherein the transparent non-conjugated polymer is selected from a group consisting of polyacrylate and derivatives thereof, polyethylene and derivatives thereof, polystyrene (PS) and derivatives thereof, polyvinyl pyridine and derivatives thereof, polyacrylamide, polyvinyl alcohol (PVA), polyester (PES), polycarbonate (PC), cyclic olefin, and polyacrylic acid (PAA).

6. The luminescent fiber material as claimed in claim 5, wherein the polyacrylate derivatives comprise polymethyl acrylate, poly(n-butylacrylate), or poly(tert-butylacrylate).

7. The luminescent fiber material as claimed in claim 1, wherein the conjugated luminescent polymer is PPV, and the transparent non-conjugated polymer is poly(methylmethacrylate) (PMMA).

8. The luminescent fiber material as claimed in claim 1, wherein a weight ratio of the conjugated luminescent polymer to the transparent non-conjugated polymer is from 1/99 to 99/1.

9. The luminescent fiber material as claimed in claim 1, further comprising a solvent or a co-solvent.

10. The luminescent fiber material as claimed in claim 9, wherein the solvent comprises tetrahydrofuran (THF), toluene, chloroform, or dimethyl formamide (DMF).

11. The luminescent fiber material as claimed in claim 9, wherein the co-solvent is a co-solvent formed by at least two solvents selected from THF, toluene, chloroform, and DMF.

12. The luminescent fiber material as claimed in claim 11, wherein a volume ratio of THF to DMF is from 100/0 to 50/50.

13. The luminescent fiber material as claimed in claim 1, further comprising a salt.

14. The luminescent fiber material as claimed in claim 13, wherein the salt comprises a tetramethylammonium salt.

15. The luminescent fiber material as claimed in claim 13, wherein the content of the salt is less than 5 wt %, based on the total weight of the luminescent fiber material.

16. A luminescent fiber, made by using a luminescent fiber material as claimed in claim 1 through an electro-spinning process.

17. The luminescent fiber as claimed in claim 16, having a diameter between 50 nm and 3000 nm.
